(19) United States
(12) Patent Application Publication
(10) Pub. No.: US 2016/0080276 A1
(43) Pub. Date: Mar. 17, 2016

(54) METHODS AND ARRANGEMENT FOR ADAPTING QUALITY OF SERVICE FOR A PRIVATE CHANNEL BASED ON SERVICE AWARENESS

(71) Applicant: TELEFONAKTIEBOLAGET L M ERICSSON (PUBL), Stockholm (SE)

(72) Inventor: Henrik BASILIER, Täby (SE)

(21) Appl. No.: 14/784,987

(22) PCT Filed: Apr. 25, 2013
(86) PCT No.: PCT/SE2013/050459

§ 371 Date: Oct. 16, 2015

(51) Int. Cl. H04L 12/859; H04L 12/46

(52) U.S. Cl. CPC H04L 47/2475; H04L 12/4641; H04L 12/4633

(57) ABSTRACT

Methods, a user node and an arrangement for adapting a quality of service of a network connection during a user application session. A whole network connection between a user node and a network node, for instance a VPN tunnel, is assigned to a single QoS level at any given time, after which this assignment may be modified dynamically based on detected data traffic belonging to certain applications. Furthermore, by correlating an identity as obtained from the detected data traffic with authentication information, the identity of the user for which an adaptation of the QoS shall be requested is obtained. The QoS of an encrypted or scrambled network connection during an application session is adapted for the identified user.

### TECHNICAL FIELD

This disclosure relates to methods, a user node, an arrangement and a computer program for adapting a quality of service of a network connection during a user application session.

### BACKGROUND

There is a desire to provide a quality of service (QoS) of an encrypted or scrambled network connection such as an Internet protocol, IP, access to a customer for a certain service according to what the customer is paying.

One approach is to apply a QoS mapping of an entire IP tunnel, although it implies that all traffic in the tunnel will be given the same priority, even if it is not required. This can imply a waste of resources. It also implies that the prioritization used for traffic in such a tunnel may not be too aggressive, as it would risk penalizing other users too severely. This however has the negative side effect that desired improvements of the quality of experience, for the services that really require it, or where someone would be prepared to pay, will be lower.

For an encrypted or scrambled Internet protocol (IP) access between a user equipment and a network server, such as for a virtual private network (VPN) tunnel between a VPN client and a VPN server, information about the service is not accessible. It is therefore not known which application is using the IP access. All data packets passing over the IP access, possibly belonging to different applications, would be treated as if they belonged to one application. It would not be possible to treat the data packets differently based on the application to which they belong. This is due to that the IP and application headers carrying service information are made undetectable by encryption.

By modifying the VPN server and the VPN client, it could be possible to access information about which service uses the IP access. This approach may, however, not be practically possible.

There is thus a need for an alternative approach by which an application can be allocated a certain QoS of an encrypted or scrambled network connection.

### SUMMARY

It is an object of example embodiments of the invention to address at least some of the issues outlined above. This object and others are achieved by the method and the device according to the appended independent claims, and by the embodiments according to the dependent claims.

A first example embodiment provides a method for adapting a QoS of a network connection during a user application session, where the network connection is defined between a user node and a network node of a communication system, wherein the network node further is connected to an application server participating in the user application session. The method is performed in an arrangement of the communication system, and comprises detecting data traffic between the network node and the application server, the data traffic belonging to the user application during the user application session. The method also comprises obtaining an identity associated with the user application session of the detected data traffic, and obtaining information about a relation between the obtained identity associated with the user application session and an identity of the user node. The method further comprises correlating the obtained information, with the obtained identity associated with the user session, to obtain the identity of the user node. In addition, it comprises sending a QoS-related instruction message to a policy node for up-grading the QoS of the network connection during the user application session for the identified user node.

A second example embodiment provides an arrangement that is configured for adapting a QoS of an network connection during a user application session, where the network connection is defined between a user node and a network node of a communication system, and where the network node is configured to be connected to an application server participating in the user application session. The arrangement comprises a first processing circuitry that is configured to detect data traffic between the network node and the application server, the data traffic belonging to the user application during the user application session. The arrangement comprises a second processing circuitry that is configured to be connected to the first processing circuitry and to obtain information about a relation between the obtained identity associated with the user application session and an identity of the user node. The first processing circuitry is further configured to obtain an identity associated with the user application session from the detected data traffic and to provide this identity associated with the user application session to the second processing circuitry. The second processing circuitry is further configured to determine a correspondence between the obtained identity associated with the user session and the obtained information, thereby obtaining the identity of the user node, and to provide the obtained identity of the user node to the first processing circuitry. In addition, the first processing circuitry is also configured to send a QoS-related instruction message to a policy node for up-grading the QoS of the network connection during the user application session for the identified user node.

A third example embodiment provides a method for providing authentication information for adapting a QoS of a network connection during a user application session, where the network connection is defined between a user node and a network node of a communication system, the network node being connected to an application server participating in the user application session. The method being performed in a user node, comprises requesting authentication information that relates an identity of the user application session and the identity of the user node. The method also obtains authentication information from a user of the user node or from an operating system of the user node. In addition, it comprises sending said authentication information to an arrangement that is configured to adapt the QoS of the network connection for an identified user node.

A fourth example embodiment provides a user node that is configured to provide authentication information for adapting a QoS of a network connection during a user application session, where the network connection is defined between the user node and a network node of a communication system, the network node being configured to be connected to an application server that participates in the user application session. The user node comprises a controller that is configured to request authentication information relating an identity of the user application session and an identity of the user node. The user node also comprises an interface that is connected to the controller and configured to obtain authenticating information from a user of the user node or from an operating system of the user node. In addition, the user node also comprises a transmitter that is connected to the interface and configured to send the obtained authentication information to an arrangement configured to up-grade the QoS of the network connection for an identified user node.

A fifth example embodiment provides a computer program for adapting of a QoS of a network connection during a user application session, where the network connection is defined between a user node and a network node of a communication system, and where the network node is configured to be connected to an application server participating in the user application session, comprises computer program code which, when run in an arrangement causes the arrangement to detect data traffic between the network node and the application server, the data traffic belonging to the user application during the user application session, and to obtain an identity associated with the user application session of the detected data traffic. It further causes the arrangement to obtain information about a relation between the obtained identity associated with the user application session and an identity of the user node, and to correlate obtained information, with the obtained identity associated with the user session, to obtain the identity of the user node. In addition, it causes the arrangement to send a QoS-related instruction message to a policy node for up-grading the QoS of the network connection during the user application session for the identified user node.

### BRIEF DESCRIPTION OF THE DRAWINGS

Example embodiments will now be described in more detail, and with reference to the accompanying drawings, in which:

FIG. 1 presents a communication network related to embodiments of the invention;

FIGS. 2 and 3 are flowcharts illustrating embodiments of the invention;

FIGS. 4 and 5 are signalling diagrams schematically illustrating embodiment of the invention;

FIGS. 6 and 7 present block diagrams schematically illustrating an arrangement and a user node of embodiments of the invention, respectively; and

FIG. 8 schematically illustrates a computer program product of some embodiments of the invention.

### DETAILED DESCRIPTION

In the following description, different example embodiments of the invention will be described in more detail, with reference to accompanying drawings. For the purpose of explanation and not limitation, specific details are set forth, such as particular scenarios and techniques in order to provide a thorough understanding.

There is hence a need for an alternative approach by which a QoS can be adapted of an encrypted or scrambled network connection during an application session.

It would be desirable to also distinguish between different applications or services to enable prioritization of data traffic of services only when services are used where it is required or paid for. However, as indicated above, for traditional QoS mapping of the data traffic inside an encrypted or scrambled network connection, such as a VPN tunnel, is not possible since header and/or application header information would be encrypted or scrambled, unless such a network connection approach itself is modified to reveal encrypted or scrambled data.

If attempting to obtain data traffic information from outside the network connection, for example outside the termination of the VPN tunnel, another issue has to be taken into account. Outside an encrypted network connection, e.g. after decapsulation of an encapsulated packet of the data traffic, the identity of the data traffic, for example an IP address, is typically private or belong to an particular enterprise. This identity of the data traffic cannot be used directly in a request for a QoS to a policy node since this identity is not recognized by said policy node.

Moreover, a VPN server participating in a VPN tunnel may even be hosted at the premises of the enterprise. In addition, the identity of the data traffic, as such, is therefore not directly useable for identification of a user or a user device in the communication network.

Embodiments of present invention relate to an approach of determining when data traffic is present during a user application session, and to adapt a QoS of a network connection for that data traffic to enable prioritization of the data traffic of said user application session.

Embodiments of this invention are therefore directed towards assigning a whole network connection between a user node and a network node, for instance an IP access such as a VPN tunnel, to a single QoS level at any given time, and to dynamically change this assignment based on awareness of active applications. Due to the difficulty to access information on an encrypted or scrambled network connection, information about data traffic is detected outside the termination of the network connection, where the data no longer is encrypted or scrambled. By detecting data traffic information outside the network connection termination, header or application level information can be accessed. Data traffic detection may thus be performed far away from the access network for the user application session for which the network connection is set up. Detection of said data traffic may be performed in a virtual machine, in a cloud data center or even at premises of an enterprise.

However, although detecting of data traffic is performed outside an encrypted IP access, the data traffic detection will be able to access an identity that is associated with the user application session. For instance, a private network address and information about the network domain to which the private network address belongs, may be obtained from the data detection.

Adapting of the QoS of the network connection may be performed by instructing a policy node that an identified user is using an application that is eligible for prioritization. In the detection of data traffic it can be determined when data traffic of a certain application is present. However, the identity information that is available from outside the network connection cannot directly be used to identify the user.

For this reason there is a requirement to determine to which user the detected identity associated with the user application session belongs.

By performing a correlation from the identity associated with the user application session to an identity of the user, it can be revealed to which user the detected data traffic belongs and therefore for which user the instruction message for adaptation of the network connection shall be sent. It can here be mentioned that the identity of the user may be the international mobile subscriber identity (IMSI) number, the mobile subscriber integrated services digital network number (MSISDN), or the Internet protocol (IP) address of the user node.

As will be explained in more detailed below, correlating may be performed by leveraging information collected by network entities such as AAA servers, user databases/directories, or by actively involving a client on the user side of the network connection for supplying information required for a correlation from the identity associated with the user application session to the identity of the user.

Thus, by detecting data traffic of an application, that is eligible for adaptation of the QoS and hence for prioritization, embodiments of the invention can invoke a correlation based on identity information from the data traffic detection, to obtain an identity of the user, which can be used to adapt the QoS level dynamically, e.g. by using the third Generation Partnership Project Rx interface running between an application function and a policy charging and rules function.

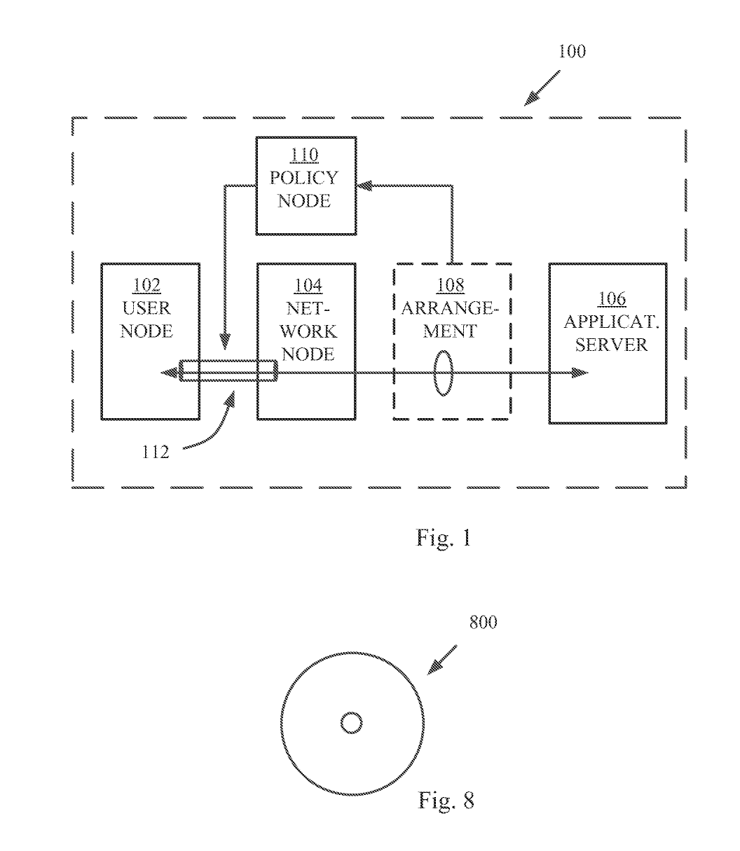

FIG. 1 provides a schematic presentation of a communication network 100 related to embodiments of this invention. The network comprises a user node 102, a network node 104, an application server 106, an arrangement 108, and a policy node 110. A network connection 112 is established between the user node 102 and the network node 104 for a user application session involving the application server 106. Based on detection of data traffic outside the termination of the network connection information can be gained about the application. This information together with the identity of the user node may then be sent to the policy node in an instruction to adapt the QoS of the network connection between the user node and the network node. The QoS can be either up-graded or down-graded based on the detection of traffic data outside the termination of the network connection. Detection outside the termination of a network connection is especially applicable to the case in which the data traffic between the user node and the network node is either encrypted or scrambled, which would otherwise hinder a meaningful data detection to be performed between the user node and the network node.

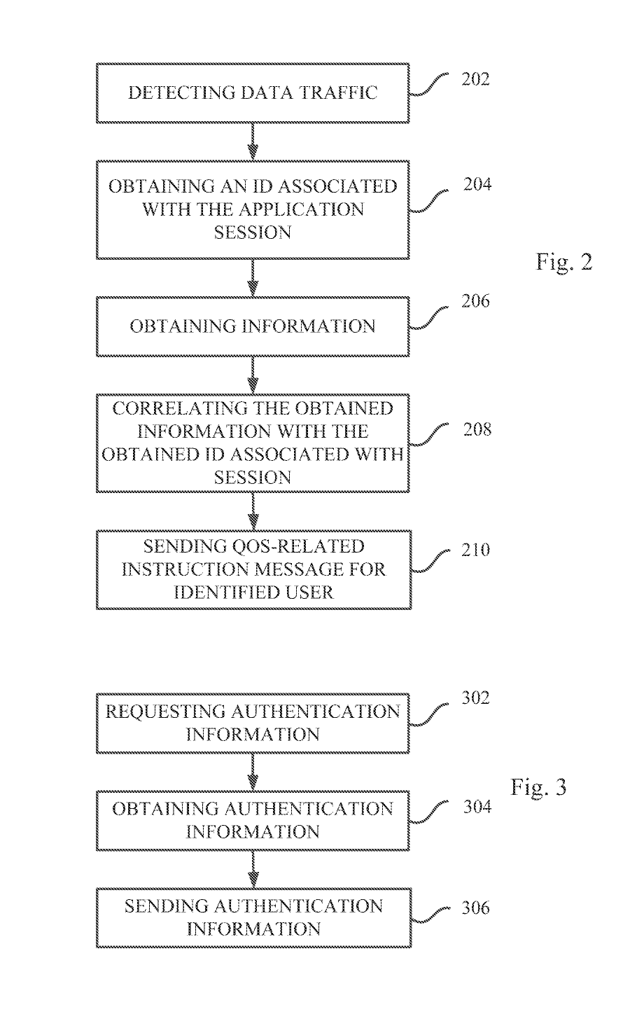

FIG. 2 presents a flowchart of a general method for adapting a QoS of a network connection during a user application session, according to some embodiments of the present invention. The network connection is defined between a user 102 node and a network node 104 of a communication system, where the network node is connected to an application server 106 participating in the user application session. The method is performed in an arrangement 108 of the communication system, and comprises detecting 202 data traffic between the network node and the application server, where the data traffic belongs to the user application during the user application session, and obtaining 204 an identity associated with the user application session of the detected data traffic. The method further comprises obtaining 206 information about a relation between the obtained identity that is associated with the user application session, and an identity of the user node. It also comprises correlating 208 the obtained information with the obtained identity associated with the user session, to obtain the identity of the user node. In addition, the method comprises sending 210 a QoS-related instruction message to a policy node for up-grading the QoS of the network connection during the user application session for the identified user node.

Correlating herein is defined as to identify an unambiguous correspondence. By correlating the obtained information with the obtained identity associated with the user application session, an unambiguous correspondence between the user application session and the identity of the user node is obtained. This is due to that the obtained information relates an identity of the user node and an identity associated with the user application session.

The network node 104 of the method for adapting a QoS of a network connection during a user application session, may be a proxy server, and wherein the identity associated with the user application session comprises an IP-address and a port number. In this case, the available information about the identity of the data traffic is thus the IP address of the proxy server in combination with the number of the port being used for the user application session. In this embodiment, a database or a server may comprise a relation between identity information of the user and the IP address of the proxy server together with the port number. This relation may then be used in a correlation to reveal the identity of the user, to be used for the instruction message to adapt the QoS for the network connection.

As the QoS of the network connection is adapted by for instance upgrading or downgrading the QoS, both the uplink as well as the downlink is affected by this adaptation. Data traffic in uplink as well as in downlink will hence benefit from an upgrade of the QoS of the network connection. This is due to that the bearer, which is allocated resources by the adaptation of the QoS carries data traffic in both uplink and downlink.

In general, the network connection between the user node 102 and the network node 104 may be an IP-tunnel.

The network connection may comprise an IP access such as a VPN, tunnel, for which the network node may be VPN server.

The information as obtained in 206 may comprise authentication information obtained from an authentication, authorization and accounting (AAA) server or information obtained from the user node 102.

Upon detecting no data traffic belonging to the user application for a pre-determined time period, or detecting a data packet explicitly indicating down-grading of the QoS, a QoS-related instruction message may be sent to the policy node for down-grading the QoS of the network connection.

It should be noted that the QoS may be upgraded or downgraded based on the detecting of data traffic. Upgrading of QoS may be formed performed from a first level of QoS to a second level, after which downgrading may be performed from said second level to said first level. Alternatively, several levels of QoS, between which the QoS can be changed, are also envisaged. For example, the QoS for the network connection may be adapted by upgrading from a first level of QoS to a second level of QoS. Thereafter, upgrading may be performed from the second level to third level of QoS, and possibly further to even higher levels of QoS.

It should be noted that when adapting the QoS of the network connection for a particular user identity, the QoS adaptation is applied to all applications of the bearer of network connection for the identified user. Upon detection of data traffic for an application that is eligible for upgrading, the upgrade is applied to all applications of the identified user within the bearer of the network connection. When it is determined that the QoS shall be downgraded, the QoS is downgraded for the whole network connection, for which reason it affects all applications for the particular identified user.

Since the adaptation of the QoS of the network connection is based on detection of data traffic of an application eligible for upgrading, the effect of the adaptation is that the data traffic belonging to said application is prioritized over other applications of the user. It is noted that since a single user rarely has a large number of applications running at the same time, and since the data traffic typically is packet based, it is relatively common that the data traffic of the network connection of a specific user belongs to one and the same application only, at a given time. For this reason, upgrading the QoS of the whole network connection for the eligible application can be performed at a limited cost. The data traffic that benefits from the upgraded QoS without payment being made may thus be limited.

FIG. 3 presents a flowchart of a general method for providing authentication information for adapting a QoS of a network connection during a user application session, according to some embodiments of the present invention. The network connection is defined between a user node and a network node of a communication system, the network node being connected to an application server participating in the user application session. The method is performed in a user node and comprises requesting 302 authentication information relating an identity of the user application session and the identity of the user node, and obtaining 304 authentication information from a user of the user node or from an operating system of the user node. In addition, the method comprises sending 306 said authentication information to an arrangement that is configured to adapt the QoS of the network connection for an identified user node.

The requesting of authentication information that relates an identity of the user application session and the identity of the user node, may be triggered by signaling in relation to the establishing of the IP-access or by polling information associated with the IP-access. Said signaling may be received from a VPN client upon establishing a VPN tunnel between the VPN client and a VPN server.

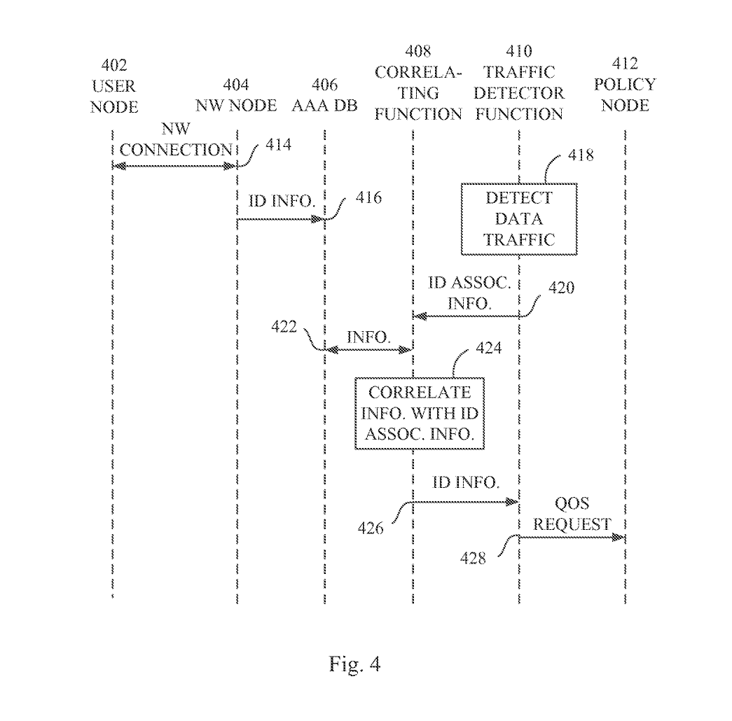

FIG. 4 presents a signaling diagram of example signaling according to embodiments of the invention, where in the signaling is performed between a user node 402, a network node 404, an authentication, authorization and accounting (AAA) database 406, a correlating function 408, a traffic detector function 410 and a policy node 412. In 414 a network connection is established between the user node 402 and the network node 404. The network connection may be encrypted, such as for a VPN tunnel, or scrambled. In case the network connection is a VPN tunnel, it is established between a VPN client and a VPN server. The VPN client may be located in the user node 402, and the VPN server may be comprised in the network node 404.

In 416 identity (ID) information is sent from the network node 404 to the AAA database. This ID information may comprise authentication information whereby a relation is created between the identity associated with the user application session and an identity used for authentication of the network connection when set up. This identity may comprise the international mobile subscriber identity (IMSI) number of the user node, the mobile subscriber integrated services digital network number (MSISDN) of user of the user node, and/or the IP address of the user node.

In 418, the traffic detector function 410 detects data traffic belonging to an application that is eligible for adaptation of the QoS of the network connection. An identity associated with the user application session is obtained from the detected data traffic.

This identity may be obtained from a header of an IP packet or an application packet of the detected data traffic. In 420, this identity associated with the user application session is sent from the traffic detector function 410 to the correlating function 408. The correlating function 408 may then consult the AAA database 406 for information that can be used to obtain the identity of the user node. In 422, the correlating function 408 obtains information about a relation between the identity associated with the user application session and the identity of user node from the AAA database 406.

The consulting of the correlating function may be performed prior to obtaining the identity associated with the user application session. In this case the correlating function typically obtains large amounts of information. Correlating may then be performed of said large amounts of data with the identity associated with the user application session, to obtain an identity of the user node.

The correlating function 408 may hence ask the AAA database 406 to obtain information relating the identity of the user node 402 and the identity associated with the user application session. This identity may comprise the IMSI, the MSISDN, or the IP address of the user node, as indicated above. Alternatively, the identity of the user node may comprise an identity that was used for authentication of the network connection. In this case a translation from the identity that was used for authentication of the network connection to the IMSI, MSISDN or IP address of the user node, is performed.

In 424, the correlating function 408 performs a correlation of the obtained information about the relation between the identity associated with the user application session and the identity of the user node, between the identity associated with the user application session, to achieve the identity of the user node. In 426, the identity of the user node is sent from the correlating function 408 to the traffic detector function 410. In 428, the traffic detector function sends a QoS-related instruction message to a policy node 412 for upgrading the QoS of the network connection during the user application session for the identified user node. The policy node may be a policy charging and rules function or possibly an intermediary node that will be responsible for the request of the QoS for the adaptation of the QoS of the network connection.

In the signaling diagram of FIG. 4, correlating can be handled without the need of user input, such as via a user client.

FIG. 5 presents another signaling diagram according to embodiments of the present invention. The signaling as performed in this signaling diagram involves a correlating client. Signaling is performed between a user node 502, a correlating client 506, a network node 504, a correlating function 508, a traffic detector function 510 and a policy node 512. In 514 a network connection is established between the user node 502 and the network node 504. The network connection may be encrypted, such as for a VPN tunnel, or scrambled. In case the network connection is a VPN tunnel, it is established between a VPN client and a VPN server. The VPN client may be located in the user node 502, and the VPN server may be comprised in or co-located with the network node 504.

In 516, authentication information is provided from the user node 502 to the correlating client 506, which may be located in the user node 502. This authentication information may comprise information that was used for authentication of the network connection in the establishment of the network connection. In 516 the correlating client also obtains an identity associated with the user application session, from the user node 502.

In 518, information that relates the identity of the user node with the identity that is associated with the user application session is provided to the correlating function 508. The identity of the user node may comprise IMSI number of the user node, the MSISDN number of user of the user node, and/or the IP address of the user node.

In 520, the traffic detector function 510 detects data traffic that belongs to an application based on which the adaptation of the QoS of the network connection is performed. An identity associated with the user application session is obtained from header information of the detected data traffic. In 522, this identity associated with the user application session is sent from the traffic detector function 510 to the correlating function 508. In 524, the correlating function 508 correlates the obtained information, which relates the identity associated with the user application session with the identity of user node 502, with the identity associated with the user session, to achieve the identity of the user node 502. In 526, the identity of the user node 502 is sent from the correlating function 508 to the traffic detector function 510. In 528, the traffic detector function may then send a QoS-related instruction message, such as a request, for upgrading the QoS of the IP-access during the user application session for the identified user node.

The signaling diagram of FIG. 5 presents an example in which a correlating client is involved in the signalling, which is in contrast to the signalling diagram of FIG. 4. After the network connection has been established in 514, the correlating client 506 may send a registration message to the correlating functionality 508 of the communication system. This registration message may comprise both a useable identity of the user, or an identifier that relates to the identity of the user, as well as an identity associated with the user session for the application. The correlating client may obtain this information via signalling or calls to the operating system of the user node.

As indicated above, embodiment of the present invention also comprises adaptation of QoS of a network connection wherein the adaptation comprises a downgrading of the QoS. A QoS request for a downgrade may thus be sent in 528, when no data traffic has been detected for the application that is eligible for prioritization, or when a data packet explicitly indicating down-grading of the QoS has been detected.

Generally, the policy node may after receipt of the QoS request for adaptation of the QoS of the network connection:

upgrade the QoS of a default bearer of the network connection, which bearer can be shared by data traffic of many users and applications;

upgrade the QoS of a dedicated bearer, used for encrypted or scrambled network connection traffic, which is useful if some traffic bypasses the network connection; or

change mapping/filtering of encrypted network connection data traffic, e.g. by adding a filter rule to a dedicated bearer such that the encrypted traffic will be mapped to this, instead of being mapped to a default bearer.

When no application eligible for prioritization has been detected or is considered to be active, all encrypted data traffic may be sent without prioritization.

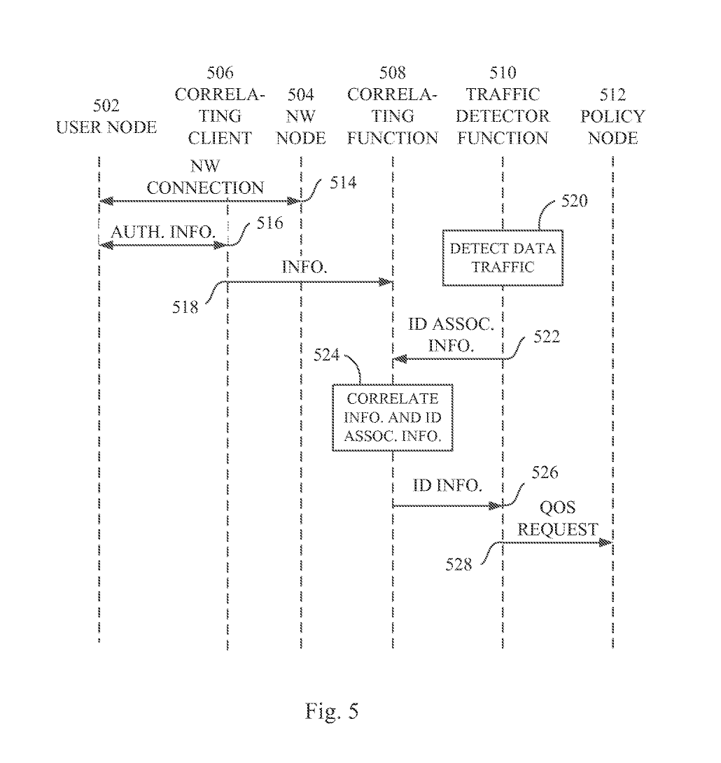

FIG. 6 presents a block diagram of an arrangement 600 that is configured to adapt a QoS of a network connection during a user application session, where the network connection is defined between a user node 102; 402; 502 and a network node 104; 404; 504 of a communication system, and where the network node is configured to be connected to an application server 106 participating in the user application session. The arrangement comprises a first processing circuitry 602 that is configured to detect data traffic between the network node and the application server, where the data traffic belongs to the user application during the user application session. The arrangement further comprises a second processing circuitry 604 that is configured to be connected to the first processing circuitry 602 and to obtain information about a relation between the obtained identity associated with the user application session and an identity of the user node. The first processing circuitry 602 is further configured to obtain an identity associated with the user application session from the detected data traffic and to provide this identity associated with the user application session to the second processing circuitry 604. The second processing circuitry 604 is further configured to determine a correspondence between the obtained identity associated with the user session and the obtained information, thereby obtaining the identity of the user node, and to provide the obtained identity of the user node to the first processing circuitry 602. The first processing circuitry 602 is in addition also configured to send a QoS-related instruction message to a policy node for up-grading the QoS of the network connection during the user application session for the identified user node.

The first processing circuitry of the arrangement may further be configured to detect data traffic belonging to the user application during the user application session from a copy of the data traffic.

Although the arrangement comprises a first processing circuitry 602 that is configured to detect data traffic between the network node and the application server, said first processing circuitry does not have to be located between the network node and the application server, but may detect data traffic of an application of data traffic that is a copy of the data traffic between the network node and the application server. For this reason, the traffic of data between the network node and the application server is not affected by the detecting per se.

It is noted that the first processing circuitry is configured to detect data traffic of an application. This may be performed in presence of other data traffic belonging to one or more other applications and/or one or more other users. Based on IP header and/or application header information the processing circuitry may detect data traffic belonging to the user application. An identity associated with the user application session is also obtained from the header information.

The first processing circuitry of the arrangement may comprise a traffic detector or a traffic detector functionality.

The first processing circuitry of the arrangement may further be configured to detect that no data traffic belonging to the user application for a pre-determined time period, or to detect a data packet explicitly indicating down-grading of the QoS, and wherein the second processing circuitry further is configured to send a QoS-related instruction message to the policy node for down-grading the QoS of the network connection for the identified user node.

The first and second processing circuitry may be one and the same overall processing circuitry. In such an embodiment the arrangement comprises the overall processing circuitry.

The arrangement may be implemented in a stand-alone device, in the network node, or as a virtual machine.

The first processing circuitry may be comprised within a first computer, whereas the second processing circuitry may be comprised in a second computer. The arrangement may in the sense that the processing circuitry can be distant from each other, be virtual, such as a so-called virtual machine.

FIG. 7 presents a block diagram of a user node 700 according to embodiments of the invention. The user node 700 is configured to provide authentication information for adapting a QoS of a network connection during a user application session, where the network connection is defined between the user node and a network node of a communication system, where the network node being configured to be connected to an application server that participates in the user application session.

The user node comprises a controller 702 that is configured to request authentication information relating an identity of the user application session and an identity of the user node. The user node also comprises an interface 704 that is connected to the controller 702 and configured to obtain authenticating information from a user of the user node of from an operating system of the user node. The user node also comprises a transmitter 706 that is connected to the interface and configured to send the obtained authentication information to an arrangement configured to up-grade the QoS of the network connection for an identified user node.

The user node may comprise a virtual private network client for the network connection between the user node and the network node.

The user node may comprise a user equipment.

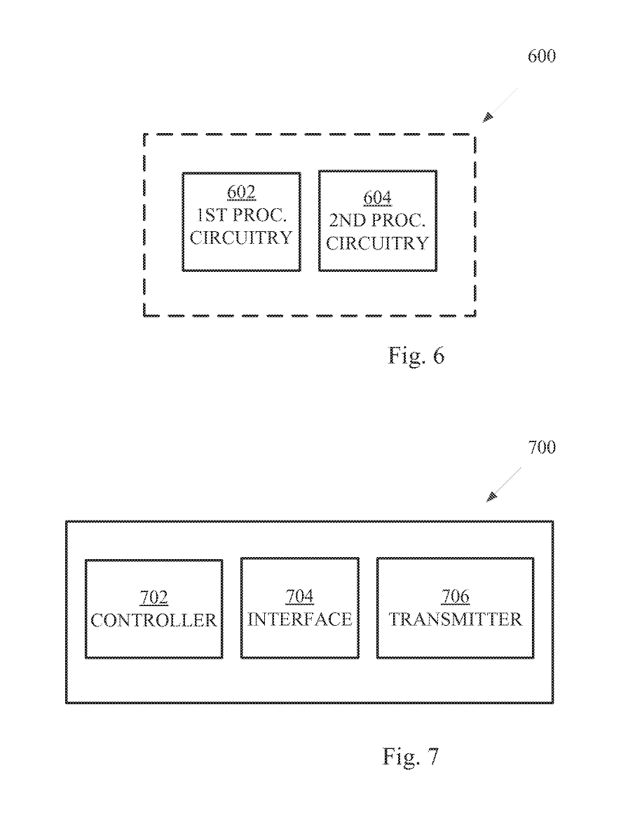

FIG. 8 schematically presents a computer program product 800 comprising a computer program for adapting of a QoS of a network connection during a user application session, and a computer readable means on which the computer program is stored. The computer program for adapting of a QoS of a network connection during a user application session, where the network connection is defined between a user node and a network node of a communication system, and where the network node being connected to an application server participating in the user application session, comprises computer program code which, when run in an arrangement causes the arrangement to:
detect 202; 418; 520 data traffic between the network node and the application server, the data traffic belonging to the user application during the user application session;
obtain 204; 420; 522 an identity associated with the user application session of the detected data traffic;
obtain 206; 422; 518 information about a relation between the obtained identity associated with the user application session and an identity of the user node;
correlate 208; 424; 524 the obtained information with the obtained identity associated with the user session, to obtain the identity of the user node; and
send 210; 428; 528 a QoS-related instruction message to a policy node for up-grading the QoS of the network connection during the user application session for the identified user node.

Embodiments of the present invention provide a number of advantages of which one is that they enable adaptation of the QoS level of an encrypted or scrambled network connection, such as a VPN tunnel, based on an application being active, i.e. generating data traffic on the network connection, the application being eligible for adaptation, without the need to modify any already existing user node, client or server connection solutions for the network connection.

It is also an advantage that both the uplink as well as the downlink can benefit from an upgrade of a QoS of the network connection.

It may be further noted that the above described embodiments are only given as examples and should not be limiting to the present invention, since other solutions, uses, objectives, and functions are apparent within the scope of the invention as claimed in the accompanying patent claims.

### ABBREVIATIONS

AAA—authentication, authorization and accounting
IMS—IP multimedia subsystem
IMSI—international mobile subscriber identity
IP—Internet protocol
MSISDN—mobile subscriber integrated services digital network number
QoS—quality of service
VPN—virtual private network

1. A method for adapting a quality of service (QoS) of a network connection during a user application session, where the network connection is defined between a user node and a network node of a communication system, the network node further being connected to an application server participating in the user application session, the method being performed in an arrangement of the communication system, and comprising:
detecting data traffic between the network node and the application server, the data traffic belonging to the user application during the user application session;
obtaining an identity associated with the user application session of the detected data traffic;
obtaining information about a relation between the obtained identity associated with the user application session and an identity of the user node;
correlating the obtained information with the obtained identity associated with the user session, to obtain the identity of the user node; and
sending a QoS-related instruction message to a policy node for up-grading the QoS of the network connection during the user application session for the identified user node.

2. The method according to claim 1, wherein the network node is a proxy server, and wherein the identity associated with the user application session comprises an IP-address of the proxy server and a port number.

3. The method according to claim 1, wherein the network connection between the user node and the network node is an IP-tunnel.

4. The method according to claim 3, wherein the network connection comprises a virtual private network (VPN) tunnel, and wherein the network node is a VPN server.

5. The method according to claim 1, wherein the information comprises authentication information obtained from an authentication server or information obtained from the user node.

6. The method according to claim 1, upon detecting no data traffic belonging to the user application for a pre-determined time period, or detecting a data packet explicitly indicating down-grading of the QoS, sending a QoS-related instruction message to the policy node for down-grading the QoS of the network connection.

7. An arrangement configured for adapting a a quality of service (QoS) of a network connection during a user application session, where the network connection is defined between a user node and a network node of a communication system, and where the network node is connected to an application server participating in the user application session, the arrangement comprising:
a first processing circuitry configured to detect data traffic between the network node and the application server, the data traffic belonging to the user application during the user application session; and
a second processing circuitry configured to be connected to the first processing circuitry and to obtain information about a relation between the obtained identity associated with the user application session and an identity of the user node;
wherein the first processing circuitry further is configured to obtain an identity associated with the user application session from the detected data traffic and to provide this identity associated with the user application session to the second processing circuitry,
wherein the second processing circuitry further is configured to determine a correspondence between the obtained identity associated with the user session and the obtained information, thereby obtaining the identity of the user node, and to provide the obtained identity of the user node to the first processing circuitry, and
wherein the first processing circuitry in addition is configured to send to a policy node a QoS-related instruction message, for up-grading the QoS of the network connection during the user application session for the identified user node.

8. The arrangement according to claim 7, wherein the first processing circuitry further is configured to detect data traffic belonging to the user application during the user application session from a copy of the data traffic.

9. The arrangement according to claim 7, wherein the first processing circuitry further is configured to detect that no data traffic belonging to the user application for a pre-determined time period, or to detect a data packet explicitly indicating down-grading of the QoS, and wherein the second processing circuitry further is configured to send a QoS-related instruction message to the policy node for down-grading the QoS of the network connection for the identified user node.

10. The arrangement according to claim 7, wherein the arrangement is implemented in a stand-alone device, in the network node, or as a virtual machine.

11. A method for providing authentication information for adapting a quality of service (QoS) of a network connection during a user application session, where the network connection is defined between a user node and a network node of a communication system, the network node being connected to an application server participating in the user application session, the method being performed in a user node, the method comprising:
requesting authentication information relating an identity of the user application session and the identity of the user node;
obtaining authentication information from a user of the user node or from an operating system of the user node; and
sending said authentication information to an arrangement that is configured to adapt the QoS of the network connection for an identified user node.

12. The method for providing authentication information according to claim 11, wherein requesting is triggered by signaling in relation to the IP-access or by polling information associated with the IP-access.

13. A user node configured to provide authentication information for adapting a quality of service (QoS) of a network connection during a user application session, where the network connection is defined between the user node and a network node of a communication system, the network node being configured to be connected to an application server that participates in the user application session, the communication device comprising:
a controller configured to request authentication information relating an identity of the user application session and an identity of the user node;
an interface connected to the controller and configured to obtain authenticating information from a user of the user node of from an operating system of the user node; and
a transmitter connected to the interface and configured to send the obtained authentication information to an arrangement configured to up-grade the QoS of the network connection for an identified user node.

14. The user node according to claim 13, further comprising a virtual private network client for the network connection between the user node and the network node.

15. The user node according to claim 13, wherein the user node comprises a user equipment.

16. A non-transitory computer-readable medium for adapting a quality of service (QoS) of a network connection during a user application session, where the network connection is defined between a user node and a network node of a communication system, the network node being connected to an application server participating in the user application session, the non-transitory computer-readable medium comprising computer program code which, when run in an arrangement causes the arrangement to:
detect data traffic between the network node and the application server, the data traffic belonging to the user application during the user application session;
obtain an identity associated with the user application session of the detected data traffic;
obtain information about a relation between the obtained identity associated with the user application session and an identity of the user node;
correlate the obtained information with the obtained identity associated with the user session, to obtain the identity of the user node; and
send a QoS-related instruction message to a policy node for up-grading the QoS of the network connection during the user application session for the identified user node.

17. (canceled)
